(19) United States
(12) Patent Application Publication
(10) Pub. No.: US 2021/0390413 A1
(43) Pub. Date: Dec. 16, 2021

(54) DROPOUT AND PRUNED NEURAL NETWORKS FOR FAULT CLASSIFICATION IN PHOTOVOLTAIC ARRAYS

(71) Applicants: Andreas Spanias, Tempe, AZ (US); Sunil Srinivasa Manjanbail Rao, Tempe, AZ (US); Gowtham Muniraju, Tempe, AZ (US); Cihan Tepedelenlioglu, Chandler, AZ (US)

(72) Inventors: Andreas Spanias, Tempe, AZ (US); Sunil Srinivasa Manjanbail Rao, Tempe, AZ (US); Gowtham Muniraju, Tempe, AZ (US); Cihan Tepedelenlioglu, Chandler, AZ (US)

(73) Assignee: Arizona Board of Regents on behalf of Arizona State University, Scottsdale, AZ (US)

(21) Appl. No.: 17/348,410

(22) Filed: Jun. 15, 2021

Related U.S. Application Data
(60) Provisional application No. 63/039,012, filed on Jun. 15, 2020.

(51) Int. Cl. G06N 3/08; G06K 9/62; H02S 50/10

(52) U.S. Cl. CPC G06N 3/082; H02S 50/10; G06K 9/6268

(57) ABSTRACT

Dropout and pruned neural networks for fault classification in photovoltaic (PV) arrays are provided. Automatic detection of solar array faults leads to reduced maintenance costs and increased efficiencies. Embodiments described herein address the problem of fault detection, localization, and classification in utility-scale PV arrays. More specifically, neural networks are developed for fault classification, which have been trained using dropout regularizers. These neural networks are examined and assessed, then compared with other classification algorithms. In order to classify a wide variety of faults, a set of unique features are extracted from PV array measurements and used as inputs to a neural network. Example approaches to neural network pruning are described, illustrating trade-offs between model accuracy and complexity. This approach promises to improve the accuracy of fault classification and elevate the efficiency of PV arrays.

### RELATED APPLICATIONS

This application claims the benefit of provisional patent application Ser. No. 63/039,012, filed Jun. 15, 2020, the disclosure of which is hereby incorporated herein by reference in its entirety.

### GOVERNMENT SUPPORT

This invention was made with government support under 1646542 awarded by the National Science Foundation. The government has certain rights in the invention.

### FIELD OF THE DISCLOSURE

The present disclosure relates to fault detection in solar arrays.

### BACKGROUND

Faults in utility-scale solar arrays often lead to increased maintenance costs and reduced efficiency. Since photovoltaic (PV) arrays are generally installed in remote locations, maintenance and annual repairs due to faults incur large costs and delays. To automatically detect faults, PV arrays can be equipped with smart electronics that provide data for analytics. Smart monitoring devices (SMDs) that have remote monitoring and control capability have been proposed to provide data for each panel and enable detection of faults and shading. The presence of such SMDs renders the solar array system as a cyber-physical plant that can be monitored and controlled in real-time with algorithms and software.

FIG. 1 illustrates a model of a solar cell or PV module 10 (e.g., panel) as a current source and a diode, with parasitic series and shunt resistance. The current-voltage (I-V) data in a PV array can be measured at the module level inexpensively. This data is useful since it can be used to build correlation models, and is useful in predicting ground faults, arc faults, soiling shading, and so on. The I-V characteristic is a function of temperature, incoming solar irradiance (direct and diffused), open circuit voltage (V_{oc}), and short circuit current (I_{SC}). Each PV module 10 has a peak operating point, which can be referred to as the maximum power point (MPP). Fault detection using I-V data can be accomplished by measuring MPPs (e.g., with one or more SMDs) and observing the variation of the measured MPP from the actual MPP.

Even with the presence of SMDs, fault detection and classification is challenging and requires statistical analysis of I-V and similar PV data. Traditional methods such as the support vector machine (SVM), decision tree-based approach, and a minimum covariance determinant (MCD)-based distance metric have been proposed to identify faulty conditions in PV arrays. In one approach, real-time fault detection in PV systems was studied, and a threshold-based approach developed for identifying faulty panels. Another statistical approach proposed a 3-sigma rule for detecting faults in PV modules. Methods to detect partial shading in PV systems were addressed in another approach. Although the above approaches provided encouraging results, they are based on aggregated data and generally cannot localize and distinguish between electrical faults and shading in PV systems. The ability to classify faults accurately and automatically is still an open problem.

### SUMMARY

Dropout and pruned neural networks for fault classification in photovoltaic (PV) arrays are provided. Automatic detection of solar array faults leads to reduced maintenance costs and increased efficiencies. Embodiments described herein address the problem of fault detection, localization, and classification in utility-scale PV arrays. More specifically, neural networks are developed for fault classification, which have been trained using dropout regularizers. These neural networks are examined and assessed, then compared with other classification algorithms.

In order to classify a wide variety of faults, a set of unique features are extracted from PV array measurements and used as inputs to a neural network. These features include open circuit voltage and short circuit current, and may also include one or more of: maximum voltage, maximum current, temperature, irradiance, fill factor, power, or a ratio of power over irradiance (γ). Example approaches to neural network pruning are described, illustrating trade-offs between model accuracy and complexity. This approach promises to improve the accuracy of fault classification and elevate the efficiency of PV arrays.

An exemplary embodiment provides a fault-identifying neural network for a PV array, comprising: an input layer configured to receive measurements from the PV array; a hidden layer configured to analyze the received measurements, wherein the hidden layer is a concrete dropout layer; and a decision layer configured to classify a type of fault among a plurality of types of faults in the analyzed measurements.

Another exemplary embodiment provides a method for classifying faults in a PV array, the method comprising: receiving measurements from the PV array; extracting a plurality of features from the measurements; and classifying a fault in the PV array among a plurality of types of faults based on the plurality of features using a neural network which is at least one of a pruned neural network or a concrete dropout neural network.

Another exemplary embodiment provides a solar monitoring system, comprising: a database configured to receive and store measurements from one or more PV monitoring devices; and a processor configured to classify a type of fault by concurrently comparing the stored measurements against a plurality of types of faults using a pre-trained and pruned neural network.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a model of a solar cell or photovoltaic (PV) module (e.g., panel) as a current source and a diode, with parasitic series and shunt resistance.

FIG. 2 is an image depicting an exemplary PV array which may be monitored for fault detection, classification, and localization according to embodiments described herein.

FIG. 3 is a schematic diagram of an exemplary solar monitoring system for a PV array, such as the PV array of FIG. 2.

FIG. 4 is a schematic diagram of an exemplary neural network architecture used for fault detection and classification in the solar monitoring system of FIG. 3.

FIG. 5 is a flow diagram of a process for fault detection and classification using the solar monitoring system of FIG. 3.

FIG. 6 is a graphical representation of t-distributed stochastic neighbor embedding illustrating overlapping data points between four types of fault and standard test conditions.

FIG. 7 is a schematic diagram of an exemplary process for pruning and/or regularizing the neural network of FIG. 4 used for fault detection and classification according to embodiments described herein.

FIG. 8 is a flow diagram of a process for training and pruning the neural network according to FIG. 7.

FIG. 9 is a graphical representation of test accuracy of pruned neural networks for different pruning percentages.

FIG. 10 is a graphical representation of a confusion matrix for fault classification obtained with concrete dropout.

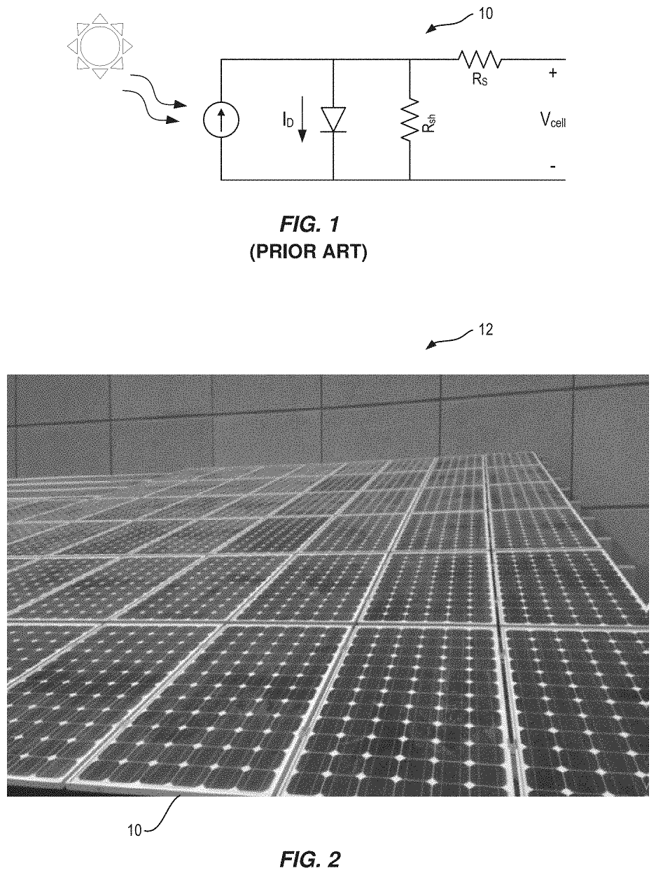

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Dropout and pruned neural networks for fault classification in photovoltaic (PV) arrays are provided. Automatic detection of solar array faults leads to reduced maintenance costs and increased efficiencies. Embodiments described herein address the problem of fault detection, localization, and classification in utility-scale PV arrays. More specifically, neural networks are developed for fault classification, which have been trained using dropout regularizers. These neural networks are examined and assessed, then compared with other classification algorithms.

In order to classify a wide variety of faults, a set of unique features are extracted from PV array measurements and used as inputs to a neural network. These features include open circuit voltage and short circuit current, and may also include one or more of: maximum voltage, maximum current, temperature, irradiance, fill factor, power, or a ratio of power over irradiance (γ). Example approaches to neural network pruning are described, illustrating trade-offs between model accuracy and complexity. This approach promises to improve the accuracy of fault classification and elevate the efficiency of PV arrays.

I. Solar Monitoring System

FIG. 2 is an image depicting an exemplary PV array 12 which may be monitored for fault detection, classification, and localization according to embodiments described herein. The exemplary PV array 12 of FIG. 2 is an 18 kilowatt (kW) array of 104 PV modules 10 (e.g., panels). Other examples may include larger or smaller arrays as appropriate.

The efficiency of solar energy systems, which may include the PV array 12, requires detailed analytics for each PV module 10 including voltage, current, temperature, and irradiance. Solar power output is affected by factors such as cloud cover, soiling of PV modules 10, short circuits between PV modules 10, unexpected faults, and varying weather conditions. Embodiments disclosed herein use machine learning and neural network approaches for fault detection. These approaches are aimed at improving the efficiency and reliability of utility scale PV arrays 12.

A. System Architecture

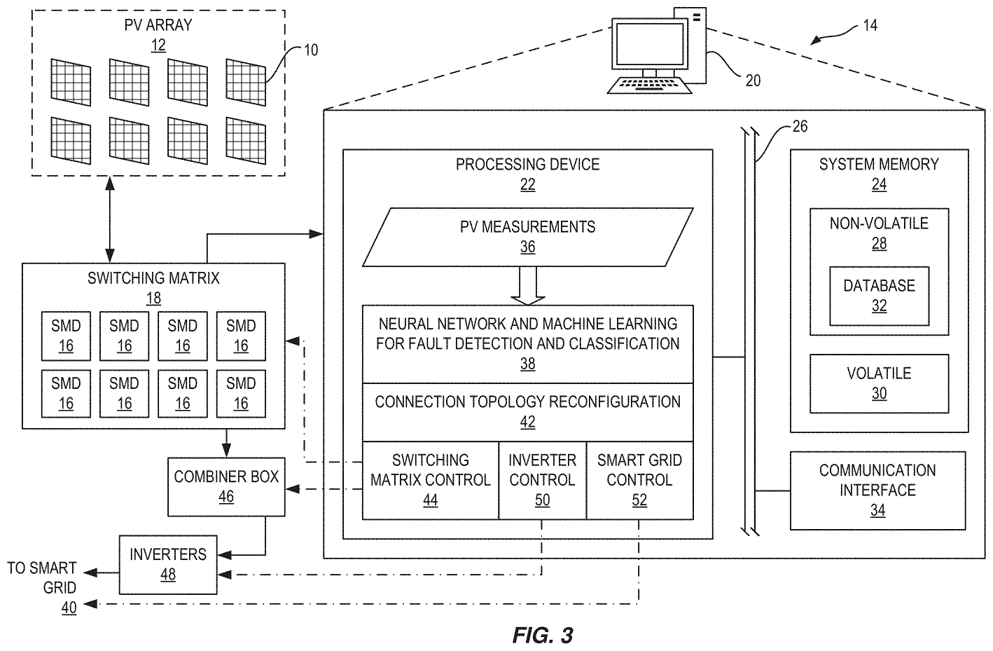

FIG. 3 is a schematic diagram of an exemplary solar monitoring system 14 for a PV array 12, such as the PV array 12 of FIG. 2. The solar monitoring system 14 improves PV module 10 efficiency using machine learning techniques to learn and predict multiple system parameters using sensors and sensor fusion. Training and test data are acquired through cyber-physical methods including sensors and actuators. The solar monitoring system also uses machine learning and deep learning algorithms for fault detection, which improves efficiency.

Parameter sensing at each PV module 10 provides information for fault detection and power output optimization. Neural networks and sensor fusion enable robust shading estimation and fault detection algorithms. In this regard, one or more smart monitoring devices (SMDs) 16 are deployed with sensors that measure current, voltage, and temperature. The data obtained from these sensors is used for fault diagnosis in one or more PV arrays 12. The SMDs 16 also have relays that enable dynamical reconfiguration of connection topologies.

With continuing reference to FIG. 2 and FIG. 3, a utility-scale PV array 12 consists of PV modules 10 that are connected as a combination of series and parallel strings to maximize power output. Shading, weather patterns, and temperature can severely affect power output. To minimize these effects, individual module current-voltage (I-V) measurements and local weather information are provided to the solar monitoring system 14 of FIG. 3. Power output is controlled through a switching matrix 18 (e.g., by providing real time topological changes with relay switches in each SMD 16) coupled to the PV array 12 (e.g., one SMD 16 per PV module 10), allowing for several interconnection options. Utility scale PV array systems are optimized by exploiting the measured I-V and weather data. In some examples, each SMD 16 is connected to a corresponding individual PV module 10 and collects metrics (current, voltage, and temperature) of the individual PV module 10 periodically (e.g., every eight to ten seconds).

In an exemplary aspect, the solar monitoring system 14 includes or is implemented as a computer system 20, which comprises any computing or electronic device capable of including firmware, hardware, and/or executing software instructions that could be used to perform any of the methods or functions described herein, such as classifying faults in the PV array 12. In this regard, the computer system 20 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 20 in this embodiment includes a processing device 22 or processor, a system memory 24, and a system bus 26. The system memory 24 may include non-volatile memory 28 and volatile memory 30. The non-volatile memory 28 may include read-only memory (ROM), erasable programmable read-only memory (EPROM), electrically erasable programmable read-only memory (EEPROM), and the like. In some examples, the non-volatile memory 28 includes a database 32 storing measurements from the PV array 12, instructions, program modules, and the like. The volatile memory 30 generally includes random-access memory (RAM) (e.g., dynamic RAM (DRAM), such as synchronous DRAM (SDRAM)).

The system bus 26 provides an interface for system components including, but not limited to, the system memory 24 and the processing device 22. The system bus 26 may be any of several types of bus structures that may further interconnect to a memory bus (with or without a memory controller), a peripheral bus, and/or a local bus using any of a variety of commercially available bus architectures.

The processing device 22 represents one or more commercially available or proprietary general-purpose processing devices, such as a microprocessor, central processing unit (CPU), or the like. More particularly, the processing device 22 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 22 is configured to execute processing logic instructions for performing the operations and steps discussed herein.

In this regard, the various illustrative logical blocks, modules, and circuits described in connection with the embodiments disclosed herein may be implemented or performed with the processing device 22, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 22 may be a microprocessor, or may be any conventional processor, controller, microcontroller, or state machine. The processing device 22 may also be implemented as a combination of computing devices (e.g., a combination of a DSP and a microprocessor, a plurality of microprocessors, one or more microprocessors in conjunction with a DSP core, or any other such configuration).

An operator, such as the user, may also be able to enter one or more configuration commands to the computer system 20 through a keyboard, a pointing device such as a mouse, or a touch-sensitive surface, such as a display device, via an input device interface or remotely through a web interface, terminal program, or the like via a communication interface 34. The communication interface 34 may be wired or wireless and facilitate communications with any number of devices via a communications network in a direct or indirect fashion. Additional inputs and outputs to the computer system 20 may be provided through the system bus 26 as appropriate to implement embodiments described herein.

Human operators are currently required to manually perform fault detection and identification in PV arrays 12. Studies have shown that the current method for mean time to repair (MTTR) is approximately 19 days. There is a significant need to reduce MTTR to reduce power losses from the PV array 12. The solar monitoring system 14 of FIG. 3 uses machine learning methods to reduce the MTTR for PV arrays 12.

Fault identification and localization problems pose several challenges. The solar monitoring system 14 must first accurately classify the PV array 12 condition and then react to unseen data to correctly classify the condition of operation of the PV array 12. Considering these challenges, the solar monitoring system 14 uses machine learning techniques. Semi-supervised learning can be used to label many realistic faults from few measured examples.

As described further below, the solar monitoring system 14 incorporates a unique set of custom features for fault detection and identification. In an exemplary aspect, the processing device 22 may be configured to implement machine learning algorithms described herein to detect, classify, and localize faults. The machine learning algorithms operate on measurements 36 received from the PV array 12 (e.g., via the SMDs 16 coupled to individual PV modules 10). The processing device 22 implements a custom neural network and machine learning for fault detection and classification 38 for the one or more PV arrays 12 (e.g., using parametric models). Accordingly, embodiments can detect and identify/classify multiple (e.g., eight) different commonly occurring cases in PV arrays 12 concurrently. In addition, the custom neural network can be regularized as a dropout neural network (e.g., a concrete dropout neural network) and/or pruned to improve performance and efficiency.

The processing device 22 can further use the outputs from the neural network to control aspects of the PV array 12 and a smart grid 40. For example, the SMDs 16 can perform module switching or bypassing if necessary. The processing device 22 can use relays in the SMDs 16 to reconfigure multiple connection topologies 42 (e.g., with a switching matrix control function 44, which may also control a combiner box 46). Inverters 48 which connect the PV array 12 to the smart grid 40 or another alternating current (AC) power system can also be controlled by an inverter control function 50. Finally, control of the smart grid 40 may be provided via a smart grid control function 52.

B. Neural Network Architecture.

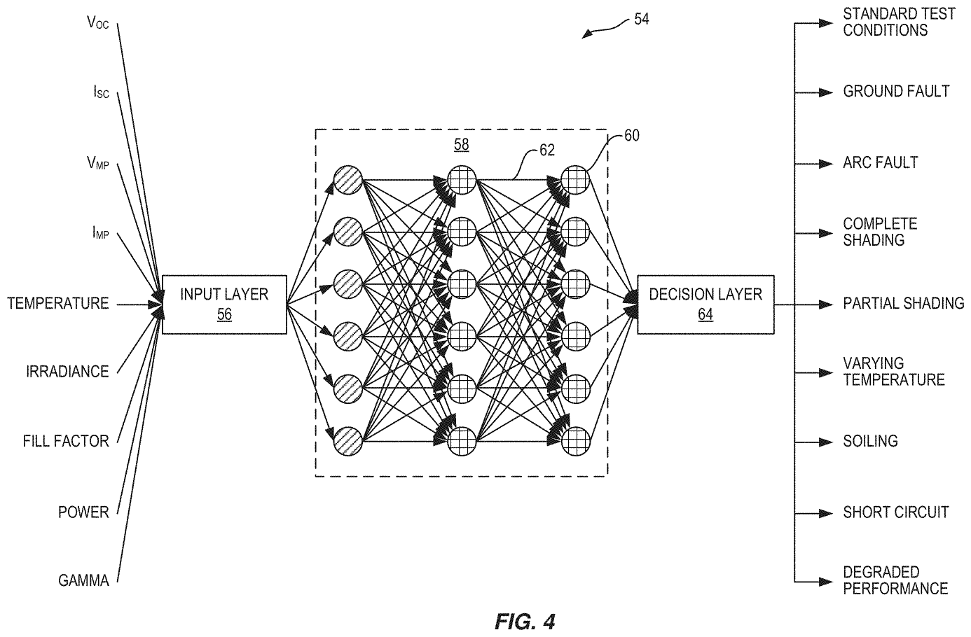

FIG. 4 is a schematic diagram of an exemplary neural network 54 architecture used for fault detection and classification in the solar monitoring system 14 of FIG. 3. The neural network 54 architecture provides a comprehensive algorithm which encapsulates a wide variety of faults. To do this, a multi-layer feedforward neural net is used with multiple inputs as features. A set of unique features is selected as inputs to the neural network 54 and is critical in identifying the type of fault.

The maximum voltage (Vₘₚ) and maximum currents (Iₘₚ) lie at the knee of the I-V curve of a PV module/array. These two features help identify the power produced by the PV module/array. Power is chosen as a third feature to help classify shading.

The next set of features includes irradiance and temperature. Irradiance and temperature are critical features which help identify shading conditions from varying temperature conditions. Vₘₚ and Iₘₚ for shading and varying temperature conditions lie at similar points along the I-V curve, making it difficult to classify the two cases. With these two critical features, along with those previously mentioned, shading can be separated from temperature conditions.

Other features can be considered, such as gamma (γ)—the ratio of power over irradiance, and fill factor—a ratio of the product of the short circuit current (I_{sc}) and open circuit voltage (V_{oc}) over Vₘₚ and Iₘₚ. These two features capture the area of the I-V curve along different dimensions which help classify multiple shading conditions. For example, multiple shading conditions can include partial shading versus complete shading of the module.

The features V_{oc} and I_{sc} are considered to help in classifying shading versus soiling. Shading and soiling often have overlapping data points and hence it is difficult to identify one versus the other. However, the difference between the two is captured in open circuit voltage and short circuit current causing these two features to serve as distinguishing parameters to identify shading versus soiling.

In some embodiments, the neural network 54 uses V_{oc}, I_{sc}, Vₘₚ, Iₘₚ, temperature of module, irradiance of module, fill factor, power, and gamma to classify eight cases. The eight faults classified are ground fault (Gnd), arc fault (Arc), complete module shading (Fully Shaded), partial module shading (Partial Shading), varying temperatures of module (Varying Temp), soiling (Degraded), short circuits (SC), and standard test conditions (STC) with irradiance at 1000 W/m² and a module temperature of 25° C.

The features mentioned above are applied as inputs to a multilayer feedforward neural network 54, which may be referred to as a multilayer perceptron (MLP). In some embodiments, a 5-layered neural network 54 is deployed with backpropagation to optimize the weights used in each layer. Measurement features (e.g., V_{oc}, I_{sc}, Vₘₚ, Iₘₚ, temperature, irradiance, fill factor, power, and gamma) are received at an input layer 56. One or more hidden layers 58 (e.g., 3 hidden layers) provide machine learning with neurons 60 which may be fully connected or sparsely connected by synapses 62. In some examples, each of the hidden layers 58 includes six neurons 60, though more or fewer may be deployed depending on performance requirements and available computing resources. At a decision layer 64 (which may also be considered an output layer), occurrence of a fault is detected and identified among a plurality of types of faults (e.g., ground fault, arc fault, complete shading, partial shading, varying temperature, soiling, short circuit, and standard test conditions)

Information flows through the neural network 54 in two ways: (i) in forward propagation, the MLP model predicts the output for received data, and (ii) in backpropagation, the model adjusts its parameters (e.g., weights of synapses 62 and/or neurons 60) considering errors in the prediction(s). An activation function used in each neuron 60 allows the MLP to learn a complex function mapping. Input to the model is the feature vector x, the output of the first and consecutive hidden layer 58 is given by

h₁=σ(W₁·x+b₁) Equation 1

hᵢ=σ(Wᵢ·hᵢ₋₁+b₁) Equation 2

where i is the layer size and σ is the activation function. x has a dimension of 48000×9. Each column represents a feature of the neural network 54 mentioned earlier.

The output of the MLP is obtained as:

ŷ=ϕ_{softmax}(hₒᵤₜ) Equation 3

Weights of each neuron 60 and/or synapse 62 are trained using a scaled gradient backpropagation algorithm. Each layer is assigned a tan h (hyperbolic tangent) activation function. The tan h boundary gives the best accuracy. The output layer (e.g., decision layer 64) uses a SoftMax activation function to categorize the type of fault in the PV array 12.

C. Process for Fault Detection and Classification

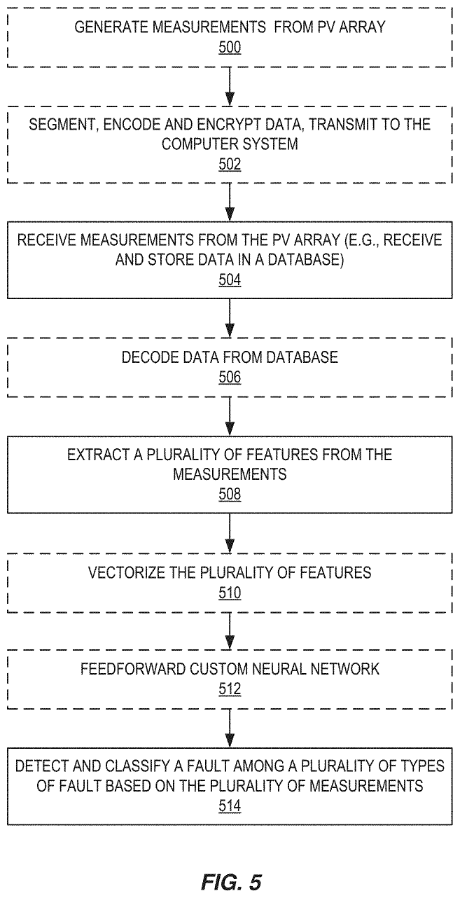

FIG. 5 is a flow diagram of a process for fault detection and classification using the solar monitoring system 14 of FIG. 3. The process described in FIG. 5 can detect and identify faults in real time. Optional steps are shown in dashed boxes. The process may optionally begin with generating measurements from a PV array (e.g., with an SMD at each PV module) (block 500). The measurements may be segmented, encoded, and encrypted as data which is transmitted to a computer system (e.g., a server implementing the neural network) (block 502).

The measurements from the PV array are received (e.g., by the computer system receiving and storing the data in a database) (block 504). The computer system optionally decodes the stored data (block 506) and extracts a plurality of features from the measurements of the PV array (block 508). The plurality of features is vectorized (e.g., at the input layer) (block 510) and passed to a feedforward custom neural network (block 512). Finally, a fault is detected and classified among a plurality of types of faults based on the plurality of features (e.g., the feature vector after being fed into the neural network) (block 514).

The solar monitoring system 14 and process for fault detection and classification may further operate as described in related U.S. patent application Ser. No. 16/868,050 entitled “Solar Array Fault Detection, Classification, and Localization Using Deep Neural Nets,” filed May 6, 2020, published as U.S. Publication No. 2020/0358396, the disclosure of which is hereby incorporated herein by reference in its entirety.

II. Fault Classes in PV Arrays

In this section, the standard test conditions and commonly occurring faults are reviewed, namely, shading, degraded modules, soiling, and short circuits. STC values correspond to the measurements yielding maximum power under the temperature and irradiance values of a particular day. A module is shaded if the irradiance measured is considerably lower than STC, usually caused by overcast conditions, cloud cover and building obstruction. As a result, the power produced by the PV array is significantly reduced.

Degraded modules are a result of modules aging or regular wear and tear of the PV modules. Consequently, such modules produce lower power values owing to the lower values of open-circuit voltage V_{oc} and short circuit current I_{sc}. Since PV modules are exposed to the environment, modules get soiled due to dust, snow, and bird droppings accumulating on the PV module. While the irradiance measured remains the same as STC, the power produced drops significantly. The final fault considered in this disclosure is short circuit conditions. This fault not only causes significant power loss but also creates potential fire hazards and severe damage to the modules.

To improve the efficiency of the PV arrays and prevent safety hazards, identifying and localizing these faults automatically is critical. As described above, the neural network 54 classifies faults using at least some of a set of nine custom input features, which includes Vₘₚ, Iₘₚ, measured irradiance, temperature, fill factor (FF), V_{oc}, I_{sc}, power, and gamma.

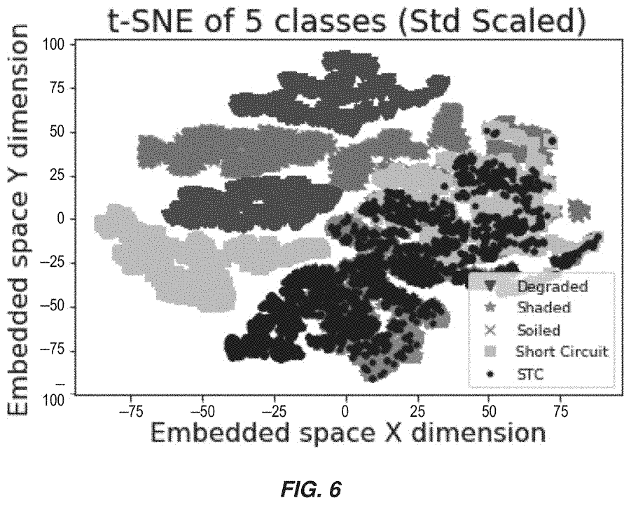

FIG. 6 is a graphical representation of t-distributed stochastic neighbor embedding (t-SNE) illustrating overlapping data points between four types of faults and STC. In order to understand the data, the t-SNE is performed, which projects the input 9-dimensional feature matrix onto lower dimensions (2-D) by minimizing the Kullback-Leibler divergence of the data distributions between the higher and the mapped lower dimensional data.

III. Dropout and Pruned Neural Networks for Fault Classification

This section describes dropout and pruned neural networks for fault classification to further improve detection and classification of faults occurring in utility-scale solar PV array systems. For example, the neural network 54 of FIG. 4 is specifically trained for solar PV fault classification using dropout and concrete dropout regularizers.

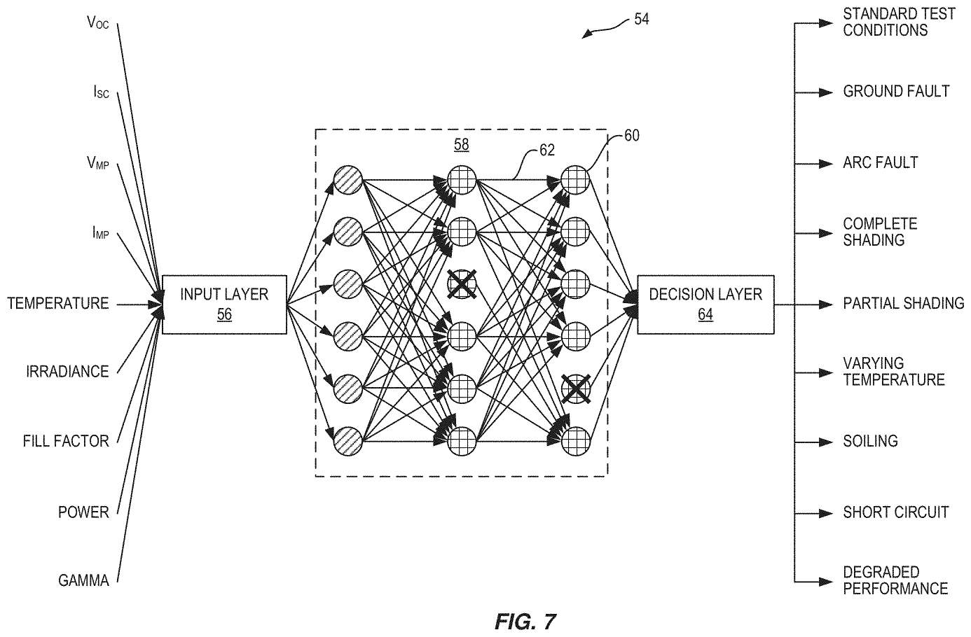

FIG. 7 is a schematic diagram of an exemplary process for pruning and/or regularizing the neural network 54 of FIG. 4 used for fault detection and classification according to embodiments described herein. FIG. 7 gives a general overview of the process where dropout neural networks are trained by randomly masking the weights of the neurons 60. Network pruning can also be performed to find sparse neural networks, at a cost of 3% decrease in accuracy for a 2× compression. Along with custom hardware, which enables monitoring voltage, current, temperature and irradiance at the module level (e.g., as described in Section I), the neural network 54 with reduced parameters will be beneficial for the development of compact and specialized hardware for fault classification in PV arrays.

With continuing reference to FIG. 7, let [symbol] ={xᵢ}ᵢ₌₁^{N} represent the d-dimensional PVWatts data and [symbol] ={yᵢ}ᵢ₌₁^{N} represent one-hot encoded labels. Consider a neural network with L layers, where z^{(l)} be the output of the l^{th} layer, Wₗ and bₗ are the weights and bias of the l^{th} layer, a(⋅) be the activation function and σ(⋅) be the soft-max layer. The output of a neural network is a class probability ŷᵢ computed as ŷᵢ=σ(zᵢ^{(L)}), where zᵢ^{(l)}=a(Wₗzᵢ^{(l-1)}+bₗ) are the activations of the hidden layer l and zᵢ⁽⁰⁾=xᵢ.

A. Dropout Neural Network

In a dropout neural network, for the lth layer, a dropout ratio p∈(0,1) is selected, and a vector of Bernoulli random variables β^{(l)} is sampled with a probability p of being 1 and 1−p of being 0. In both forward pass and back-propagation update, the weights of neurons are masked by computing element-wise product of z^{(l)} and β^{(l)}. Masking these weights during the update regularizes the network and avoids over-fitting.

B. Concrete Dropout Neural Network

Since p is a hyper-parameter, the problem of selecting p for a given dataset is crucial and performing a brute force search on a continuous variable p is computationally expensive. To address this issue, some embodiments described herein use concrete dropout neural network, in which the dropout ratio p is optimally selected for each layer by auto-tuning p. Since gradients cannot be computed for the Bernoulli distribution, concrete dropout replaces the Bernoulli distribution during training by a Gumbel-Softmax distribution, so that reparameterization can be used to compute gradients with respect to dropout probabilities.

C. Pruned Neural Networks

Pruned neural networks on embedded hardware greatly improve computational performance and reduce memory requirements with a slight reduction in the model's accuracy. Consider a fully connected neural network with N neurons in each layer initialized by weight matrices [symbol] ⁰={Wᵢ⁰}ᵢ₌₁^{L}. After training this network for t epochs, the resulting weights of the network are [symbol] ^{t}. Next, compute a mask [symbol] by pruning p % of the weights closer to zero by taking the absolute value. Reinitialize the network with [symbol] ⁰ masked by [symbol] . The network training and network pruning process is iterated until 2.5× compression is achieved, after which the networks performance degrades due to underfitting of the data.

D. Process for Training and Pruning the Neural Network

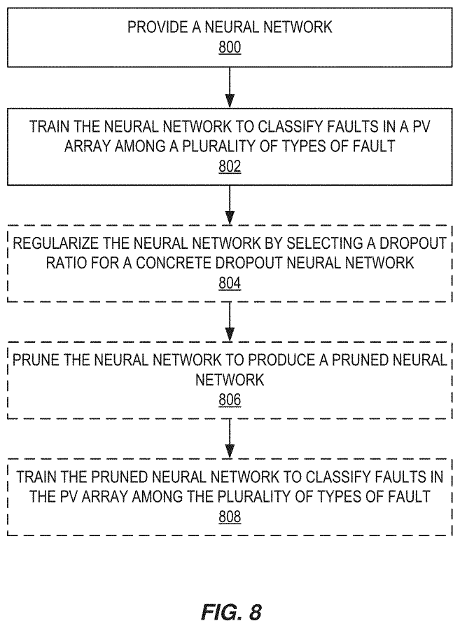

FIG. 8 is a flow diagram of a process for training and pruning the neural network according to FIG. 7. The process described in FIG. 8 can be used in conjunction with the process described in FIG. 5. Optional steps are shown in dashed boxes. The process begins with providing a neural network, such as the neural network 54 in FIG. 4 (block 800). The neural network is trained to classify faults in a PV array among a plurality of types of faults, such as described above in Sections I-B and I-C (block 802).

The neural network is optionally regularized by selecting a dropout ratio for a dropout neural network, such as a concrete dropout neural network (block 804). The dropout ratio may be selected on a per-layer basis and may further depend on the data to be analyzed. The neural network is optionally pruned to produce a pruned neural network (e.g., by computing and applying a mask) (block 806). The pruned neural network is optionally trained to classify faults in the PV array among the plurality of types of faults (e.g., in a similar manner to block 802) (block 808). Blocks 806 and 808 may be performed iteratively until a desired compression ratio and/or performance threshold is met.

IV. Simulation Results

For simulations described herein, a 9-dimensional input feature matrix (as described in Section I) is provided for processing by the neural networks. These nine input features provide high accuracy for fault classification on simulated data. The simulation dataset contains a total of 22000 samples. The 22000×9 feature matrix is fed to the neural network 54. A 3-layer neural network is used, with 50 neurons in each layer, with tan h as the activation function for each layer. This architecture was fixed for all the neural network simulations, to avoid any bias which may occur during training and testing. Multiple uniform dropout architectures are considered, with dropout probabilities p∈(0.1, 0.2, 0.3, 0.4, 0.5).

Table I shows accuracy and run time for various algorithms. The results are also compared against a fully connected neural network according to FIG. 4 (baseline). A Monte Carlo simulation is performed on all the architectures mentioned to obtain estimates for training and testing. The training (70%) and testing (30%) dataset were sampled randomly in each run of the Monte Carlo simulation. Dropout architectures perform quite well in terms of accuracy and run time. In fact, concrete dropout provided the best results. Among all the dropout architectures, an improvement of 0.5% is seen when using a concrete dropout architecture in comparison to the fully connected neural network.

TABLE I

| | Accuracy | (%) | Test Dataset | Comparison |
|---|---|---|---|---|
| Architecture | Train | Test | Change (%) | Run Time (ms) |
| Fully Connected | 91.62 | 89.34 | Baseline | 3.32 |
| Concrete Dropout | 91.45 | 89.87 | +0.5 | 1.19 |
| Dropout p = 0.1 | 89.71 | 89.34 | 0 | 1.25 |
| Dropout p = 0.2 | 89.29 | 89.13 | −0.21 | 1.69 |
| Dropout p = 0.3 | 88.92 | 88.77 | −0.57 | 1.18 |
| Dropout p = 0.4 | 87.38 | 87.20 | −2.14 | 1.05 |
| Dropout p = 0.5 | 85.51 | 85.42 | −3.92 | 1.01 |
| RFC | 100 | 86.32 | −3.02 | 3.21 |
| KNA | 87.15 | 85.76 | −3.58 | 3.35 |
| SVM | 83.51 | 83.29 | −6.05 | 3.42 |

Performance of these embodiments of the neural network is compared with standard machine learning algorithms, such as support vector machines (SVM), K-nearest neighbor algorithm (KNA), and random forest classifier (RFC), with results reported in Table I. For these machine learning algorithms, a range of parameters is empirically searched, with the best configuration chosen. RFC was trained with 300 estimators with a depth of 50, SVM was trained with radial basis kernel and KNA with 30 nearest neighbors. Techniques such as RFC overfit the training data, while other classifiers such as SVM and KNA perform poorly compared to neural networks.

For the network pruning simulations, neural networks with 3 hidden layers each were used, with N={50, 100, 200, 500, 1000} neurons. All neural networks were trained for 150 epochs and at every pruning iteration 10% of the remaining weights were pruned.

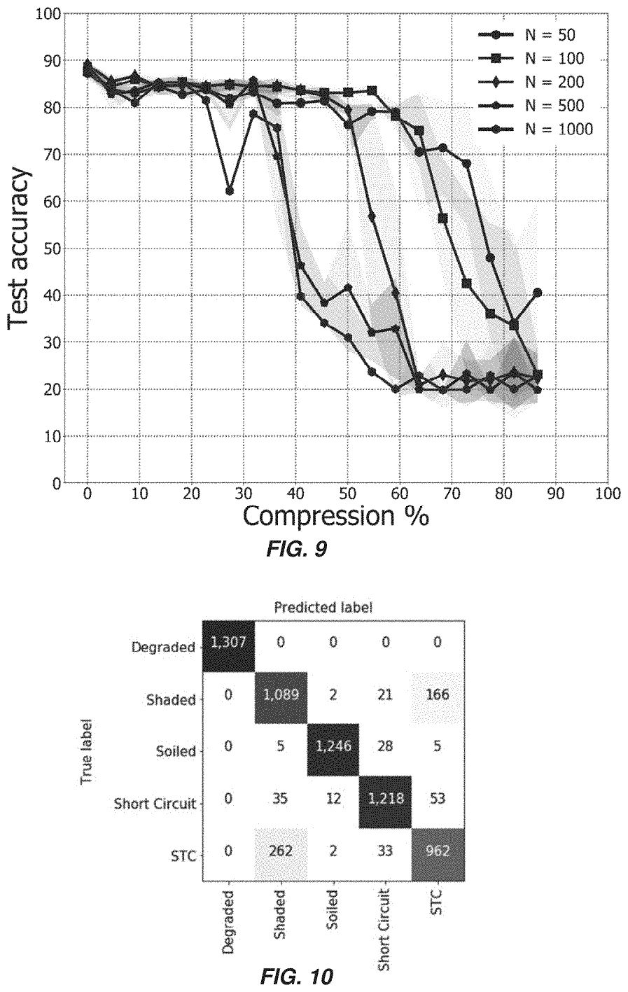

FIG. 9 is a graphical representation of test accuracy of pruned neural networks for different pruning percentages. Smaller networks achieve greater compression of about 62% for a drop in accuracy by 4%. The performance of larger networks degrades by up to 40% after pruning the network.

FIG. 10 is a graphical representation of a confusion matrix for fault classification obtained with concrete dropout. Interestingly, the overlapping points shown in FIG. 6 correspond to the incorrectly classified points in the confusion matrix, which is approximately 10% of the data.

Those skilled in the art will recognize improvements and modifications to the preferred embodiments of the present disclosure. All such improvements and modifications are considered within the scope of the concepts disclosed herein and the claims that follow.

What is claimed is:

1. A fault-identifying neural network for a photovoltaic (PV) array, comprising:
an input layer configured to receive measurements from the PV array;
a hidden layer configured to analyze the received measurements, wherein the hidden layer is a concrete dropout layer; and
a decision layer configured to classify a type of fault among a plurality of types of faults in the analyzed measurements.

2. The fault-identifying neural network of claim 1, wherein the neural network is a pruned neural network.

3. The fault-identifying neural network of claim 2, wherein the hidden layer comprises a plurality of neurons with a set of weights which have been pruned as compared with a fully-connected layer.

4. The fault-identifying neural network of claim 1, wherein:
in forward propagation, the fault-identifying neural network predicts an output comprising the type of fault; and
in backpropagation, the fault-identifying neural network adjusts its parameters based on prediction errors.

5. The fault-identifying neural network of claim 1, further comprising one or more additional hidden layers, each of which is a concrete dropout layer.

6. The fault-identifying neural network of claim 5, comprising three hidden layers, each of which has a dropout ratio which is separately tuned from the other hidden layers.

7. The fault-identifying neural network of claim 5, wherein each hidden layer comprises a plurality of neurons with a set of weights which have been pruned as compared with a fully-connected layer.

8. The fault-identifying neural network of claim 1, wherein the fault-identifying neural network is further configured to classify the type of fault on a per-PV module basis by assessing the received measurements against two or more of a ground fault, an arc fault, complete shading, partial shading, varying temperature, soiling, a short circuit, or standard test conditions of the PV array.

9. The fault-identifying neural network of claim 1, wherein the measurements from the PV array are received by the input layer as a feature vector comprising a plurality of measurements for a plurality of PV features.

10. The fault-identifying neural network of claim 9, wherein the plurality of PV features comprises open circuit voltage, short circuit current, and one or more of: maximum voltage, maximum current, temperature, irradiance, fill factor, power, or a ratio of power over irradiance (γ).

11. The fault-identifying neural network of claim 9, wherein the plurality of PV features comprises open circuit voltage, short circuit current, maximum voltage, maximum current, temperature, irradiance, fill factor, power, and a ratio of power over irradiance (γ).

12. A method for classifying faults in a photovoltaic (PV) array, the method comprising:
receiving measurements from the PV array;
extracting a plurality of features from the measurements; and
classifying a fault in the PV array among a plurality of types of faults based on the plurality of features using a neural network which is at least one of a pruned neural network or a concrete dropout neural network.

13. The method of claim 12, further comprising training the neural network to classify the fault in the PV array among the plurality of types of faults.

14. The method of claim 13, further comprising regularizing the neural network by selecting a dropout ratio for the concrete dropout neural network.

15. The method of claim 14, wherein:
the concrete dropout neural network comprises a plurality of layers; and
the dropout ratio is tuned on a per-layer basis.

16. The method of claim 13, further comprising:
pruning the neural network to produce the pruned neural network; and
training the pruned neural network to classify the fault in the PV array among the plurality of types of faults.

17. The method of claim 12, wherein receiving the measurements from the PV array comprises receiving the measurements from each of a plurality of PV modules in the PV array.

18. The method of claim 17, further comprising:
vectorizing the plurality of features for each of the plurality of PV modules; and
passing the vectorized plurality of features through a feedforward path of the neural network.

19. A solar monitoring system, comprising:
a database configured to receive and store measurements from one or more photovoltaic (PV) monitoring devices; and
a processor configured to classify a type of fault by concurrently comparing the stored measurements against a plurality of types of faults using a pre-trained and pruned neural network.

20. The system of claim 19, further comprising the one or more PV monitoring devices, each of which is configured to measure voltage, current, and temperature of a corresponding PV module.
